(19) United States
(12) Patent Application Publication
(10) Pub. No.: US 2026/0220035 A1
(43) Pub. Date: Jul. 30, 2026

(54) REMEMBER AND RECALL A DIGITAL MEMORY ACROSS MULTI-DEVICE ECOSYSTEM

(71) Applicant: MOTOROLA MOBILITY LLC, WILMINGTON, DE (US)

(72) Inventors: AMIT KUMAR AGRAWAL, BANGALORE (IN); NAKUL PATEL, NAGPUR (IN); KRISHNAN RAGHAVAN, BANGALORE (IN)

(21) Appl. No.: 19/041,302

(22) Filed: Jan. 30, 2025

(51) Int. Cl. G06F 12/02

(52) U.S. Cl. CPC G06F 12/023

(57) ABSTRACT

Various techniques are provided for remembering and recalling information related to activities engaged in by a user while using services associated with an electronic device and services associated with one or more connected electronic devices. By remembering the information related to the activities associated with the electronic device and the information related to the activities associated with one or more connected electronic devices, the techniques may enable grouping and remembering different activities that share the similar context. The techniques may further enable recalling information related to multiple activities that share the similar context. The techniques may include using artificial intelligence (AI) to analyze the information related to different activities to determine whether the information have similar context.

### BACKGROUND

### 1. Technical Field

The present disclosure relates generally to electronic devices that store information, and more particularly to electronic devices that store information that can be later retrieved.

### 2. Description of the Related Art

Electronic communication devices such as smartphones and laptops enable users to use various productivity tools to perform everyday tasks such as generating documents, communicating with families and friends, planning for vacations, participating in meetings, etc. In a fast-paced environment, a device user can be actively involved in many tasks or activities and may use many different electronic devices and/or applications to complete aspects of a particular task. Typically, when a user is involved in multiple overlapping tasks or activities using different devices and/or different applications on a single device, it can be difficult for the user to remember the details of each task at a later time.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, in one or more embodiments;

FIG. 2 illustrates a further block diagram of the electronic device configured to remember information related to activities engaged in by a user using the electronic device 100 and a connected second electronic device, in one or more embodiments;

FIG. 3 illustrates a software platform diagram of an artificial intelligence (AI) operating system (OS) of the electronic device of FIG. 1A, in one or more embodiments;

FIG. 4 illustrates a block diagram for a multi-devices activity management (MDAM) module for managing activities engaged in by a user based on the user using the electronic device and a second electronic device, in accordance with one or more embodiments;

FIGS. 5A-5B illustrate an example set of user electronic devices and example activities engaged in by a user using the set of user electronic devices during a first time period, in accordance with one or more embodiments;

FIGS. 6A-6B illustrate activities engaged in by the user during a second, subsequent time period, and further illustrates recalling of previously remembered information related to activities engaged in by the user with a set of user electronic devices during the first time period, in accordance with one or more embodiments;

FIG. 7A illustrates an example remember user interface (UI) selector presented within the display of electronic device, along with information related to activities that the user is engaging in using the electronic device and the connected second electronic device during a first time period, in accordance with one or more embodiments;

FIG. 7B illustrates an example recall UI selector presented within the display of electronic device, along with information related to activities that the user is engaging in using the electronic device during a second time period, in accordance with one or more embodiments;

FIG. 8 is a flow diagram presenting computer-implement method for remembering information related to activities engaged in by the user during one time period and for recalling the remembered information during a subsequent time period, in accordance with one or more embodiments;

FIG. 9 is a flow diagram presenting a computer-implement method that augments the method of FIG. 8 for receiving a trigger to recall and for recalling previously remembered information in response to determining a context of a third activity, in accordance with one or more embodiments;

FIG. 10 is a flow diagram presenting a computer-implement method that augments the method of FIG. 8 and the method of FIG. 9 by presenting the recalled or remembered information in an original form or in an altered form, in accordance with one or more embodiments; and

FIG. 11 is a flow diagram presenting a computer-implement method that augments the method of FIG. 8 for remembering information in response to detecting a trigger to remember and for determining which of the one or more activities in the first set of activities and which of the one or more activities in the second set of activities to remember when the trigger to remember is detected, in one or more embodiments.

### DETAILED DESCRIPTION

According to aspects of the present disclosure, an electronic device, a method and a computer program product provide various techniques for remembering and recalling information related to activities engaged by a user while using services associated with an electronic device and services associated with one or more connected electronic devices. By remembering the information related to the activities associated with the electronic device and the information related to the activities associated with one or more connected electronic devices, the techniques may enable grouping and remembering different activities that share the similar context. The techniques may further enable recalling information related to multiple activities that share the similar context. The techniques may include using artificial intelligence (AI) to analyze the information related to different activities to determine whether the information have similar context. In one or more embodiments, the recalling of the information previously remembered based on having similar context can occur when a recall trigger is detected. Alternatively, the recalling of the information previously remembered based on having the similar context can occur automatically based on analyzing information related to an activity that the user currently engages in using the services of the electronic device. In some embodiments, the disclosure provides techniques for recalling and presenting the previously remembered information in a similar format as when the information was remembered. Alternatively, the disclosure provides techniques for recalling and presenting the previously remembered information in a format (e.g., summarized format) different from the original format from when the information was remembered.

Examples of the activities that the user engages in using the electronic device or the connected second electronic device may include engaging in a voice call, engaging in a text messaging session, engaging in an online meeting, watching a video, engaging in a chat session, browsing using a network browser, and generating a document. For purposes of the disclosure, “first set of activities” is described as activities engaged in by the user using the electronic device, and “second set of activities” is described as activities engaged in by the user using the connected second electronic device. There can be one or more connected second electronic devices, and each connected second electronic device can be associated with a different second set of activities. The first set of activities and the second set of activities can occur during a similar (i.e., overlapping} time period (or first time period). Further, a “third set of activities” is described as activities engaged in by the user using the electronic device during a different time period (or second time period) subsequent to the first time period.

During normal operation in an environment when a user is using both the electronic device and the connected electronic device, a communication session can be established between the electronic device and the connected second electronic device. The communication session can be established and maintained automatically when both the electronic device and the connected second electronic device are active. In an environment where there are multiple connected second electronic devices, the communication session can be established and maintained automatically between the electronic device and only the connected active second electronic device(s).

The embodiments disclosed herein address and overcome the aforementioned issues/problems/limitations in current technology by configuring the device to remember information related to activities engaged in by the user when the activities involve using the electronic device and the connected second electronic device based on the activities sharing a similar context. In an example, when the user triggers a remember operation, a remember module of the electronic device can include program instructions that cause or configure processor 112 to cause electronic device 100 to store information about a budget document that the user is generating using the electronic device and information about a text messaging session that the user is having with a spouse about their eating out habits using a connected second electronic device because both activities share the similar context of expenses. The embodiments disclosed herein further address and overcome the aforementioned issues/problems/limitations by recalling information related to activities engaged in by the user when the activities involve using the electronic device and the context of a current activity is similar to a context of previously remembered information. By presenting the previously remembered information, the user is more aware of past related activities while engaging in the current activity. The determination of identifying the context of an activity and determining whether different activities have a similar context can be performed using artificial intelligence (AI) engines/models. The AI engines/models can be trained or may learn from the information related to the activities (e.g., content of document, content of text messages, content of phone transcript, content of meeting transcript, network browsing activities, etc.) to look for keywords, topics, concepts to derive at the appropriate context.

According to one or more embodiments, an electronic device includes at least one input device and at least one output device, including a display. The electronic device has a communications subsystem that connects the electronic device to at least one connected second electronic device via a communication network. The electronic device includes a processor communicatively coupled to the at least one input device, the at least one output device, and the communications subsystem. The processor is configured to cause the electronic device to monitor a first set of activities engaged in by a user with the electronic device during a first time period. In response to receiving a trigger to remember information related to a first activity in the first set of activities, the processor is configured to cause the electronic device to (i) analyze the information related to the first activity to determine a first context associated with the first activity, (ii) receive, via the communication subsystem from the at least one connected second electronic device, information related to a second set of activities engaged in by the user with the at least one connected second electronic device during the first time period, the second set of activities including a second activity having a second context that is similar to the first context, and (iii) create an association of the first activity and the second activity based on the second context being similar to the first context. In response to subsequently receiving a request, during a later time period, for a recall of information related to the first activity, the processor is configured to cause the electronic device to automatically retrieve and present on the display both information related to the first activity and information related to the second activity.

According to one or more embodiments, a method is provided for monitoring a first set of activities engaged in by a user with an electronic device during a first time period. In response to receiving a trigger to remember information related to a first activity in the first set of activities, the method includes analyzing the information related to the first activity to determine a first context associated with the first activity, receiving, from at least one connected second electronic device, information related to a second set of activities engaged in by the user with the at least one connected second electronic device during the first time period, the second set of activities including a second activity having a second context that is similar to the first context, and creating an association of the first activity and the second activity based on the second context being similar to the first context. In one or more embodiments, the method may further include, in response to subsequently receiving a request, during a later time period, for a recall of information related to the first activity, automatically retrieving and presenting on the display both information related to the first activity and information related to the second activity.

Further embodiments provide a computer program product that includes: a non-transitory computer readable medium; and program code on the computer readable medium that, when processed by a processor of an electronic device, configures the processor and/or the electronic device to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

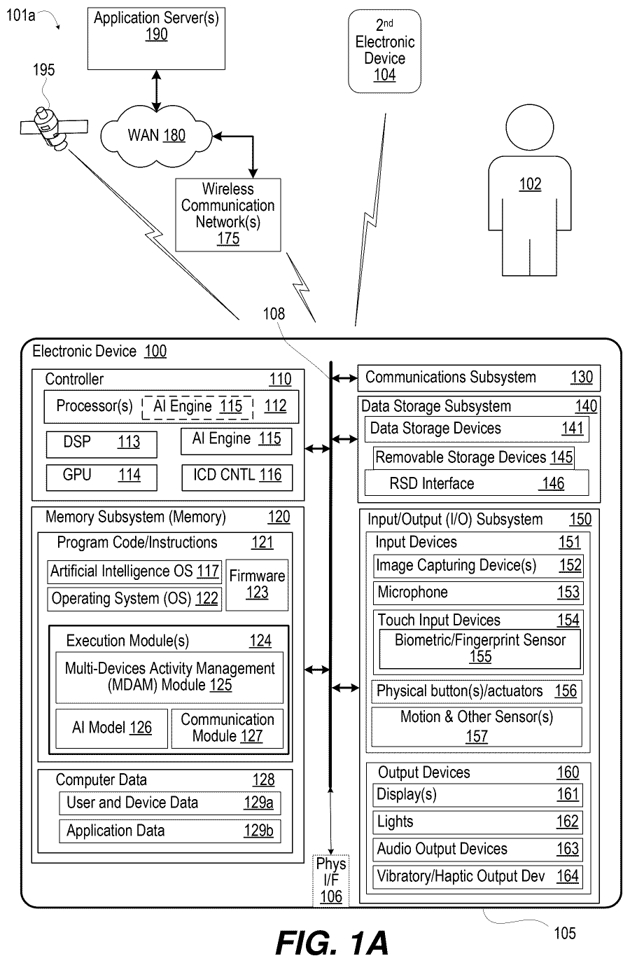

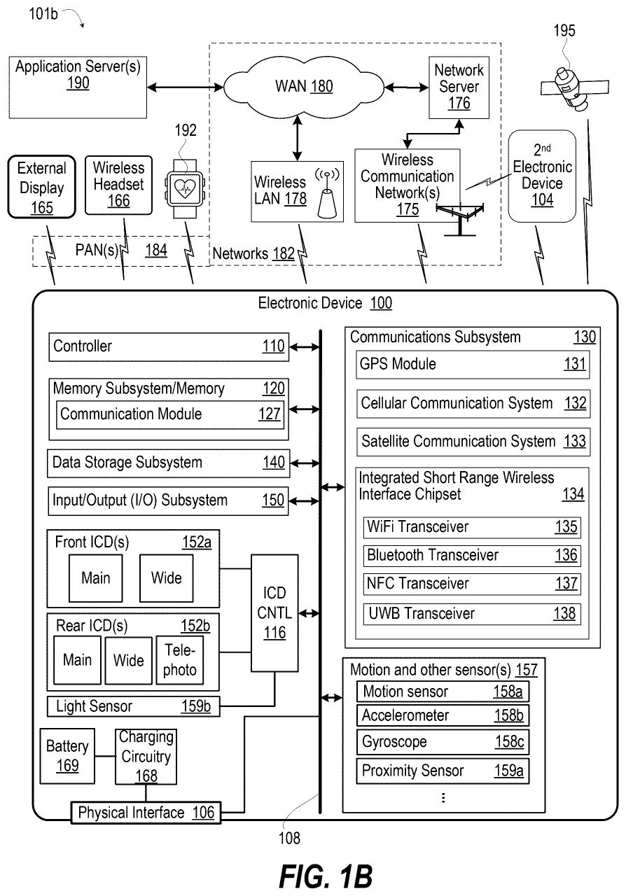

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

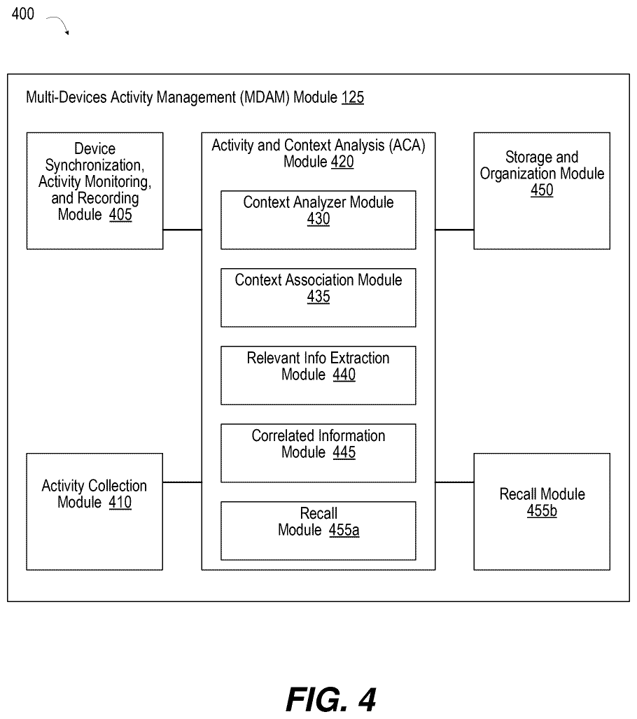

Referring now to the figures and beginning with FIG. 1A, there is illustrated a block diagram of an example electronic device 100 in communication environment 101a and having hardware and software components, which enable the features of the present disclosure to be advantageously implemented, according to one or more embodiments. Electronic device 100 is communicatively connected to one or more second electronic device(s) 104. Electronic device 100 can be programmed to detect when the one or more connected second electronic device(s) 104 is active. Electronic device 100 can detect that user 102 is engaging in an activity using one or more services or applications of the electronic device 100. Electronic device 100 can further monitor when the user 102 is engaging in activities with the one or more connected second electronic device(s) 104, as described in further details throughout this disclosure, including the description related to the device synchronization, activity monitoring and recording (DSAMR) module 405 of FIG. 4.

Examples of electronic device 100 can include, but are not limited to, mobile devices, a notebook computer, a mobile phone, a smart phone, a digital camera with enhanced processing capabilities, a smart watch, a tablet computer, and other types of electronic devices. For purposes of this disclosure, electronic device is assumed to be a communication device that can be used to engage in a voice and/or video call with a second communication device. Electronic device 100 can therefore be interchangeably referred to herein as communication device 100.

Electronic device 100 generally includes controller 110, memory (or memory subsystem) 120, communication subsystem 130, data storage subsystem 140, input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more of operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

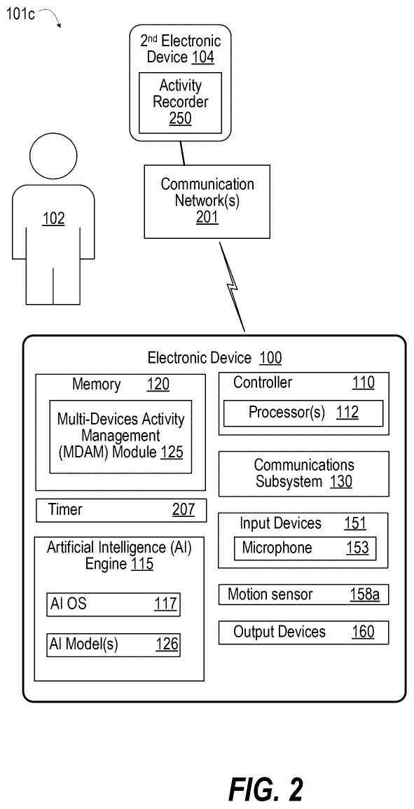

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122. Operating system 122 may include or be augmented by device AI operating system (OS) 117 that is described below with regard to FIG. 2.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, multi-devices activity management (MDAM) module 125, which provides the features and operating functionality of the disclosed embodiments when the corresponding program instructions of MDAM module 125 are processed by/within processor 112/controller 110. Further details of the MDAM module 125 are described throughout this disclosure, including the description in FIG. 4.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within MDAM module 125 and is trained to support the AI features of MDAM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, MDAM module 125 can include program instructions that cause or configure processor 112 to cause electronic device 100 to manage activities that a user engages (or has engaged) in using one or more applications on the electronic device 100 and/or the second electronic device(s) 104. Other features provided by MDAM module 125 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of MDAM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein. For example, in response to the electronic device 100 receiving a trigger to remember, the data storage device(s) 141 can store information related to the activities engaged in by the user 102 using the electronic device 100 and the one or more connected second electronic device(s) 104. In one or more embodiments, the data storage device(s) 141 can also store tag information identifying a context associated with the information related to the activities engaged in by the user 102. In one or more embodiments, in response to the electronic device 100 receiving a trigger to recall, information related to activities previously engaged in by the user 102 can be retrieved from the data storage device(s) 141.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of device housing 105. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device(s) 104 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of MDAM module 125 and/or access to other applications, online transactions, and resources. In one or more embodiments, networks 182 can also include personal area networks (PAN) 184, which are individually created with other second electronic devices (other than second electronic device 104) via one of short-range wireless devices from among Wi-Fi TxRX 135, BT TxRx 136, NFC transceiver 137, and UWB transceiver 138. Example of other second electronic devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device.

Electronic device 100 also includes a physical interface 106. Physical interface 106 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 106 can enable electronic device 100 to be physically coupled via a cable or docking station port to a second device, such as external display 165.

FIG. 1B also presents additional details of image capturing device(s) (ICD(s)) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

FIG. 2 illustrates a further communication block of electronic device 100 that enables remembering and recalling information related to activities engaged by the user 102 using the electronic device 100 and one or more connected second electronic device(s) 104, according to one or more embodiments. Communication environment 101c of FIG. 2 may include portions of communication environment 101a (FIG. 1A) and communication environment 101b (FIG. 1B). Communication initiation may be for a communication session between electronic device 100 and one or more second electronic devices 104 that are user devices for the user 102. Communication initiation may be for a communication session between electronic device 100 and with intermediary network system such as social media server 205 that is accessible to one or more second electronic devices 104 that are user devices. Second electronic device(s) 104 may include activity recorder 250 configured to monitor and record information about activities engaged in by the user 102 using the second electronic device(s) 104. The information recorded by activity recorder 250 may be transmitted to the electronic device 100 via the communication network 201. In one or more embodiments, the transmission of the information recorded by the activity recorder 250 may be performed based on a request initiated by the electronic device 100.

With reference to FIGS. 1A-1B, according to aspects of the present disclosure, electronic device 100 includes at least one input device 151 and at least one output device 160. Electronic device 100 has memory 120 including Multi-Devices Activity Management (MDAM) module 125 that may configure electronic device 100 to perform operations to remember and recall information about activities that user 102 of the electronic device 100 engages in while using the electronic device 100 and the second electronic device 104. Alternatively, or in addition, MDAM module 125 may configure electronic device 100 to recall information about activities previously engaged in by the user 102 and remembered by the electronic device 100, as described in further details throughout this disclosure, including the description related to the recall module 455a and 455b of FIG. 4.

According to one aspect of the disclosure, information related to each of the activities can be associated with a context, and information related to different activities can share a similar context. Having a similar context can include having one or more of similar topics, themes, actions, actors, or other similar characteristics. In one or more embodiments, MDAM module 125 may configure electronic device 100 to analyze information about activities engaged in by the user 102 to determine contexts and to determine whether the contexts associated with different information are similar. Electronic device 100 includes communications subsystem 130 that links electronic device 100 to communication network 201 for the one-way or two-way communication session. Processor 112 of electronic device 100 is communicatively coupled to memory 120, communications subsystem 130, at least one input device 151, and at least one output device 160.

In one or more embodiments, processor 112 is configured to cause electronic device 100 to perform background monitoring for triggers received by electronic device 100 correlated to the user 102 issuing a command to remember information related to certain activities and the user 102 issuing a command to recall information related to certain activities. In one or more embodiments, the command to recall information can be issued automatically based on a determined context.

In one or more embodiments, electronic device 100 includes microphone 153 that is communicatively coupled to processor 112. Processor 112 is further configured to cause electronic device 100 to perform background monitoring of audio input 209 received at microphone 153. Processor 112 is further configured to cause electronic device 100 to determine from audio inputs 209 that user 102 is issuing a trigger to remember information related to on-going activities or a trigger to recall the remembered information at a subsequent time.

In one or more particular embodiments, MDAM module 125 includes an artificial intelligence (AI) engine 115 trained to predict/suggest/provide/present the context associated with information related to activities engaged in by the user 102. In one or more embodiments, the AI engine 115 is trained at least in part based on crowd-sourced inputs. In one or more embodiments, the AI engine 115 is trained at least in part based on inputs originating from or associated with the user. In an example, AI engine is or includes one or more of AI OS 117 and AI model 126. In one or more particular embodiments, AI engine 115 is further trained to predict/suggest/provide/present contexts associated with information related to the activities engaged by the user 102 and/or to predict/suggest/provide/present information previously remembered and stored in the data storage subsystem 140.

In the description of each of the following figures, reference is also made to specific components illustrated within the preceding figure(s). Similar or same components are presented with the same leading reference number.

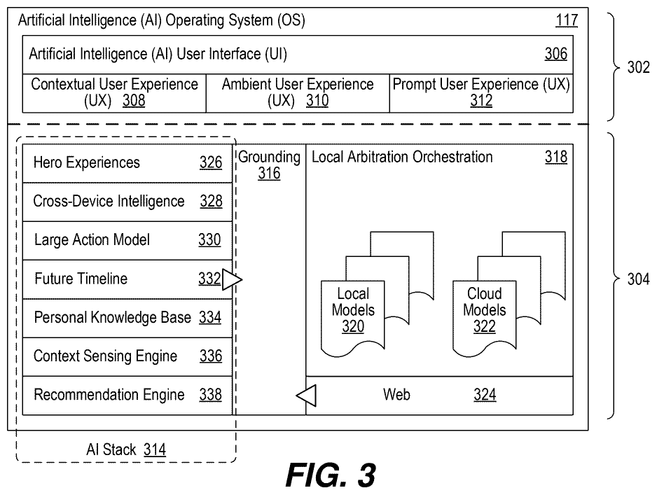

FIG. 3 illustrates a software platform diagram of an example artificial intelligence (AI) operating system (OS) 117. By learning about the user, AI OS 117 can analyze information about activities of the user to determine contexts, associate different activities that share similar contexts, and recommend/suggest/provide/present previously stored information having contexts similar to a context associated with one or more on-going activities engaged in by the user 102, thus improving user experience by enabling the user 102 to be exposed to available relevant information. AI OS 117 supports functionality of MDAM module 125 (FIG. 1B) that monitors and detects user engagement with the electronic device 100 and with one or more connected second electronic device(s) 104, analyze information related to the activities to determine context(s), and determine when information related to different activities share similar context(s). AI OS 117 includes user plane 302 supported by control plane 304. User plane includes AI user interface (UI) 306 that supports contextual user experience (UX) component 308, ambient UX component 310, and prompt UX component 312. Control plane 304 includes AI agents 314 that communicate via grounding component 316 to local arbitration orchestration component 318 having local models 320 and cloud models 322. AI agents 314 communicates via grounding component 316 to web interface 324. AI agents 314 includes hero experiences agent 326, cross-device intelligence agent 328, large action model 330, future timeline 332, personal knowledge base 334, context sensing engine 336, and recommendation engine 338.

User experience (UX) design is defined as a multidisciplinary field that focuses on enhancing the overall experience that individuals have when interacting with a digital product, system, or service. UX design encompasses various aspects of user interaction, including usability, accessibility, aesthetics, and overall satisfaction. UX design aim to create meaningful and positive experiences for users by understanding their needs, behaviors, and preferences.

Grounding component 316 in AI is an essential process that ensures AI systems comprehend and interact with the real world accurately. Grounding is a bridge between abstract AI concepts and practical, tangible outcomes. Grounding allows AI systems to bridge semantic gaps in the real world, team with other agents in such environments, process inputs from the environment, and learn from interactions. A successful synthetic teammate requires several cognitive capacities, including situation assessment, task behavior, language comprehension and generation, and knowledge gap resolution processes. Grounding enables agents with different capabilities to communicate.

FIG. 4 illustrates a block diagram 400 for the MDAM module 125 for managing activities engaged in by a user based on the user using the electronic device and a second electronic device, in accordance with one or more embodiments. The functionality of MDAM module 125 may be based on the functionality of one or more of the DSAMR module 405, activity collection module 410, remember module 450, and recall module 455. In one or more embodiments, the functionality of the MDAM module 125 may further be based on the functionality of the activity and content analysis (ACA) module 420, which can perform operations to receive information about the activities engaged in by the user 102 and analyze the information to determine contexts, and associate different information sharing similar contexts. Execution of the MDAM module 125 (and its sub-modules) includes execution of instructions by the processor 112 or the AI engine 115 to perform various described features of the MDAM module 125.

The DSAMR module 405 can include program instructions that cause or configure processor 112 to cause electronic device 100 to establish a connection between the electronic device 100 (e.g., laptop) and one or more of the second electronic device(s) 104 (e.g., smart phone, tablet). The DSAMR module 405 can include program instructions that cause or configure processor 112 to cause electronic device 100 to manage data synchronization across multiple devices (e.g., the electronic device 100 and one or more of the connected second electronic device(s) 104) to ensure consistency and timely updates. Additionally, the DSAMR module 405 can continuously monitor, gather, and record user activities across multiple devices, including receiving information recorded by the activity recorder 250 of the second electronic device(s) 104. Some examples of the activities can include engaging in a voice call using a cellular connection, engaging in an online meeting using a video conferencing application, watching a video using a streaming application, engaging in a chat session using a messenger application, browsing using a network browser, and generating a document using a word processor. For one or more embodiments, the recording of the user activities (or the information related to the activities) may be temporarily stored to anticipate any impending remember command issued by the user 102. For example, when there is no detection of a trigger to remember during a telephone call activity, one or more portions of previously recorded information about the telephone call may be erased after a certain time period.

The activity collection module 410 may be activated based on receiving a trigger to remember issued by the user 102. The trigger can be issued by selecting a remember selector via a user interface. Alternatively, or in addition, the trigger can be issued using a voice command received via the microphone 153 (FIG. 1A). In one or more embodiments, the trigger to remember can be issued while the user is engaging in an activity and can cause information related to one or more on-going activities to be remembered. In some other embodiments, the trigger to remember can additionally cause information related to one or more activities completed within a predetermined time frame prior to the detection of the trigger to be remembered. An example of an activity that was completed includes an activity having information that has been recorded and the recording is still available for the remember operations.

The activity collection module 410 may collect or gather information about the activities that the user 102 is engaging in when the trigger to remember is detected. In one or more embodiments, the collecting or gathering of the information about the activities can include previously recorded activities together with information about on-going activities. For example, the activity collection module 410 can collect information about a video call that the user 102 is engaging in using a connected second electronic device 104 and information about a document that the user 102 is generating using the electronic device 100.

The activity and context analysis (ACA) module 420 is invoked as a result of detecting the trigger to remember. The ACA module 420 includes context analyzer module 430, context association module 435, relevant information extraction module 440, and related information association module 445. The context analyzer module 430 analyzes the information collected by the activity collection module 410 to determine context and intent of an activity. In the situations when there are multiple activities occurring when the trigger to remember is detected, each activity is analyzed by the context analyzer module 430. The context association module 435 associates a determined context with the information related to the corresponding activity. In the situations when there are multiple activities, it can be possible that two or more activities share a similar context.

In one or more embodiments, the relevant information extraction module 440 can analyze the information related to an activity (as collected by the activity collection module 410 in an original form) and generate a variation of the information (in a modified form) by extracting relevant information from the information in the original form. For example, a document generation activity can generate a document that is three pages long, and a variation of the information related to the same document generation activity in the altered or modified form can be a condensed summary of the document that is half a page long. As another example, a video meeting activity can be recorded resulting in a one-hour long video, and a variation of the information related to the same video meeting activity can be only a transcript of the conversations that take place during the video meeting activity.

In one or more embodiments, the information related to an activity or the associated extracted relevant information can be used to create tasks to be performed. The AI engine 115 can be trained to analyze the information related to an activity or the associated extracted relevant information to learn about identifying tasks to be performed. The information about the tasks to be performed can be implicitly or explicitly specified. In one or more embodiments, implicitly identified tasks may be identified based on detecting information that needs more clarification. For example, information from a text messaging activity about attractions to visit in France can be used to create a task to search for information about the Eiffel tower and the Notre-Dame cathedral. In one or more embodiments, explicit tasks may be identified based on detecting information that is contextually in the form of a question or a to-do list to be performed. For example, information from a video meeting about a work project that includes issues raised with no identifiable agreeable solutions can be used to create a task to schedule a follow-up meeting to resolve issues that are left open from the same meeting.

The correlated information module 445 can determine whether the information collected by the activity collection module 410 for one activity can be correlated with the information collected for another activity based on sharing similar contexts. For example, when the user 102 is engaging in one activity relating to generating a document about malnutrition, and the user 102 is also engaging in another activity relating watching a television program teaching about nutrients, then the correlated information module 445 can associate or correlate these two activities (or the information related to these two activities) together. In one or more embodiments, the functionalities of the ACA module 420 and the included modules 430-445 can be implemented using the functionalities of the AI engine 115 (FIG. 2).

The storage and organization (SAO) module 450 can store information to data storage device(s) 141 using a structured format (e.g., relational database). The SAO module 450 can store information related to the different activities that the user 102 is engaging in when the trigger to remember is detected. The SAO module 450 can store the context determined by the context analyzer module 430 based on the information related to each of the activities. When applicable, the SAO module 450 can store information about the relationship or correlation between two or more different activities based on the corresponding information of each of the activities sharing similar contexts. In one or more embodiments, the SAO module 450 can store the information related to the different activities in an original unmodified form and/or in a modified form.

The recall module 455b can include program instructions that cause or configure processor 112 to cause electronic device 100 to recall information previously remembered and stored by the SAO module 450. The recall module 455b can be initiated based on detecting a trigger to recall. The trigger to recall can be initiated by the user 102 issuing a command via a user interface. When the trigger to recall is detected, the recall module 455b can request the SAO module 450 to search the data storage device(s) 141 to determine whether a context associated with an on-going activity is similar to any previously stored context. In response to identifying similar context, the recall module 455b can include program instructions that cause or configure processor 112 to cause electronic device 100 to cause the SAO module 450 to retrieve the remembered information associated with the similar context and present the remembered information to the user 102 via one or more output device(s) 160 (FIG. 1A). In one or more embodiments, the trigger to recall can be initiated automatically by the recall module 455a using the AI engine 115 (FIG. 2) based on detecting the similar context.

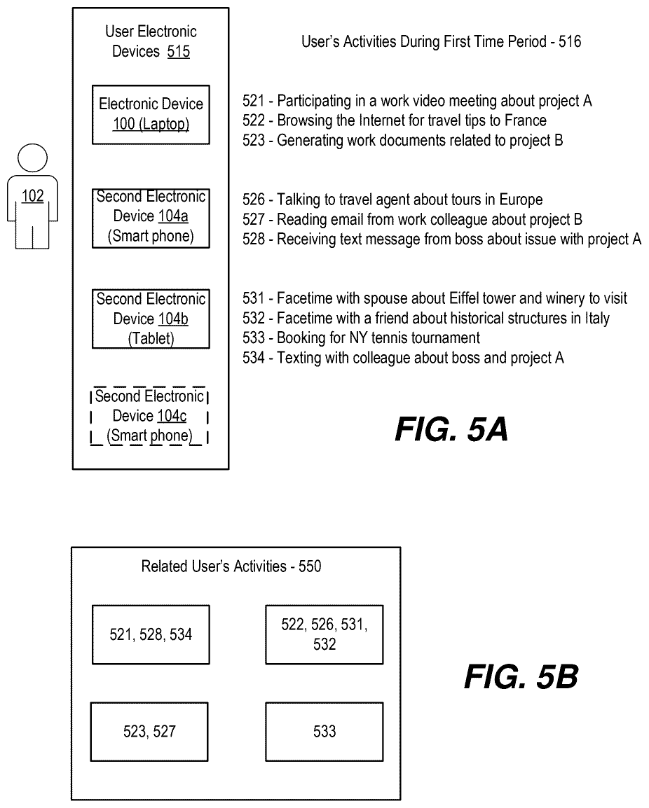

FIGS. 5A-5B illustrate example set of electronic devices 515 and example activities 516 engaged by the user 102 using the set of electronic devices 515 during a first time period, according to one or more embodiments. The set of electronic devices 515 can include the electronic device 100 (e.g., a smart phone), that can be connected to a first-connected second electronic device 104a (e.g., a smart phone), and a second-connected second electronic device 104b (e.g., a tablet). Second electronic device 104c is shown in a hyphenated block to illustrate that it is one of the user electronic devices 515, but it is either inactive or not currently connected to the electronic device 100, and therefore is not being monitored by the device monitoring processes performed via execution of the MDAM module 125. During the first time period, the user 102 can use the electronic device 100 to engage in multiple activities including participating in a work video (first activity 521), browsing the Internet (second activity 522), and generating work documents (third activity 523). During the same first time period, the user 102 is also using the first-connected second electronic device 104a to engage in multiple activities including talking to a travel agent (fourth activity 526), reading email received from a colleague (fifth activity 527), and receiving and reading text messages from a boss (sixth activity 528). During the same time period, the user 102 can use the second-connected second electronic device 104b to engage in multiple activities including facetime with the spouse (seventh activity 531), facetime with a friend (eight activity 532), booking for a tournament (ninth activity 533), and texting with another colleague (tenth activity 534). Each one of the activities can be associated with a context, as determined by the context analyzer module 430. For example, the information related to the first activity 521 is about work and more specifically about project A at work, the information related to the fourth activity 526 is also about travelling and more specifically about travelling to Europe, and the eight activity 532 is about historical structures and more specifically about historical structures in Italy.

Each activity engaged in by the user 102 can be a different type of activity. For example, an activity can be a video meeting activity, a phone conversation activity, a text messaging activity, a facetime activity, an Internet browsing activity, a word processing activity, etc. In one or more embodiments, the information related to each activity can be automatically converted into a format that can be used to determine a context. For example, content of a video meeting activity or a telephone call activity can be recorded and the audio portion can be transcribed for context analysis and determination by the context analyzer module 430.

In one or more embodiments, the information related to an activity can be tagged with a context. Two or more activities and the related information can be tagged with the same context based on the information having similar context. Referring to FIG. 5B, the example activities illustrated in FIG. 5A are grouped together as related user's activities 550 based on the activities having similar context. For example, the first, sixth, and tenth activities 521, 528 and 534 are grouped together based on sharing the context of work project A; the second, fourth, seventh and eight activities 522, 526, 531 and 532 are grouped together based on sharing the context of travelling to Europe; the third and fifth activities 523 and 527 are grouped together based on sharing the context of work project B; and the ninth activity 533 is shown in a group by itself because the ninth activity 533 (tennis tournament) is unrelated to any of the other activities. It can be noted that two or more of the example activities illustrated in FIG. 5A can be overlapping or occurring at the same time.

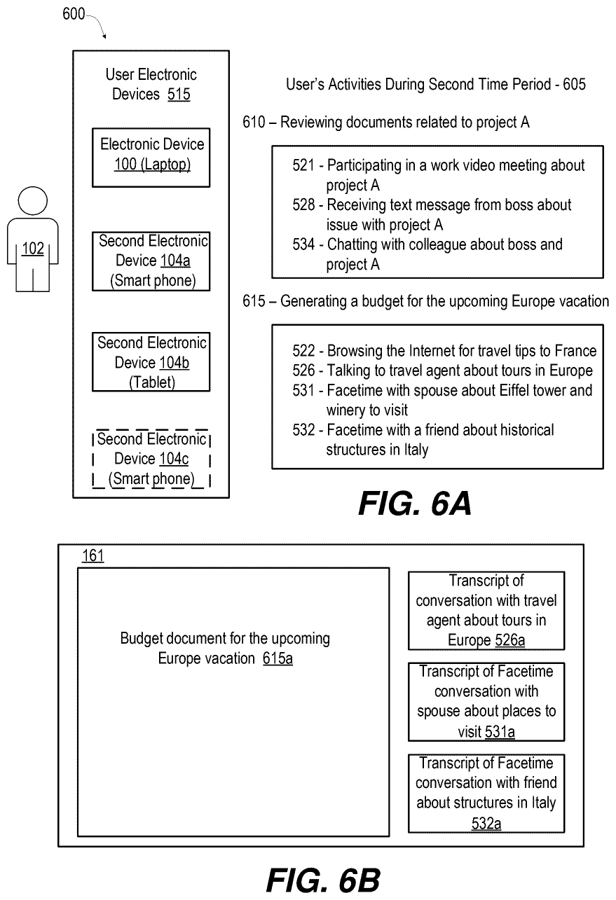

FIGS. 6A-6B illustrate activities engaged in by the user 102 during a second subsequent time period and further illustrates recalling of previously remembered information related to activities engaged by the user 102 with the set of electronic devices 515 during the first time period, according to one or more embodiments. The second time period is subsequent to the first time period. While using the electronic device 100 to engage in one or more activities (e.g., eleventh activity 610—reviewing documents related to project A, and twelfth activity 615—generating a budget for the upcoming Europe vacation), the user 102 can issue a command to trigger a recall. In response to detecting the trigger to recall, the recall module 455b can include program instructions that cause or configure processor 112 to cause electronic device 100 to request the ACA module 420 to analyze and determine the context of the on-going activities (e.g., activity 610 and activity 615), and use the determined context(s) to request the SAO module 450 to search for and retrieve any remembered information related to the same determined context(s).

As illustrated in FIG. 6A, the remembered information having similar context to the information related to the eleventh activity 610 includes information related to the first, sixth, and tenth activities 521, 528 and 534. Similarly, the remembered information having similar context to the information related to the twelfth activity 615 includes information related to the second, fourth, seventh and eight activities 522, 526, 531 and 532. As previously described, the recalling of the remembered information related to the first, sixth, and tenth activities 521, 528, 534 and the second, fourth, seventh and eight activities 522, 526, 531 and 532 can be performed automatically by the recall module 455a. In one or more embodiments, the remembered information recalled by the recall module 455a/455b can be presented to the user 102 so that the user 102 can be presented with the previously remembered information while engaging with the electronic device 100. Referring to FIG. 6B, the information 615a (budget document of twelfth activity 615) is presented within the display 161 together with the information 526a (transcript of fourth activity 526), information 531a (transcript of seventh activity 531), and information 532a (transcript of eight activity 532).

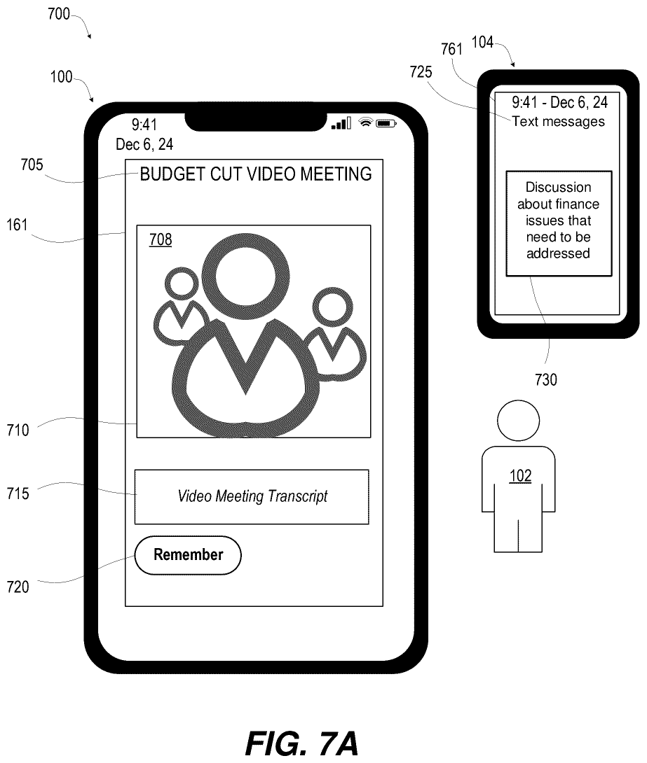

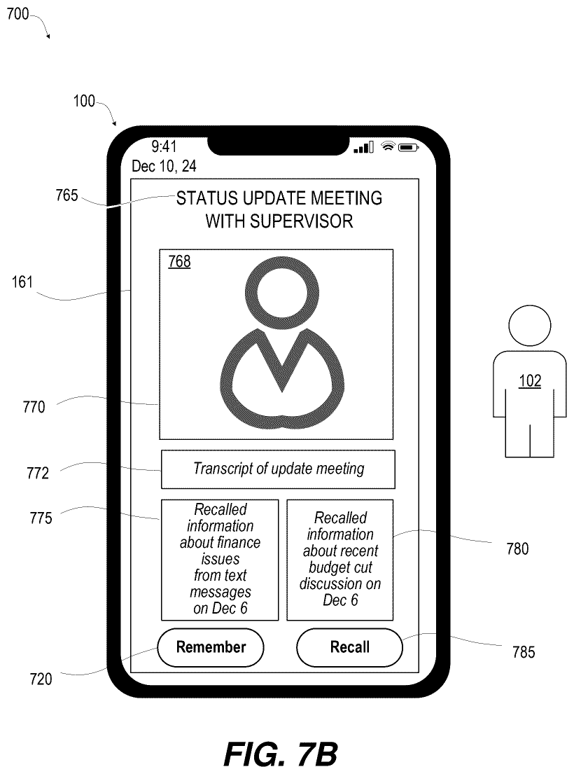

FIG. 7A illustrates an example remember selector 720 presented within the display 161 of electronic device 100, along with information related to activities that the user 102 is engaging in using the electronic device 100 and the second electronic device 104 during a first time period, according to one or more embodiments. With the electronic device 100, information related to an example video meeting activity 705 during first time period is presented within window 710 of the display 161. For example, a video 708 of the meeting activity 705 can show the user 102 and other participants in the meeting having a discussion. In one or more embodiments, a transcript of the video meeting activity 705 can be generated and presented within window 715. With the second electronic device 104, information related to an example text messaging activity 725 during the first time period can be presented within window 730.

When applicable, the user 102 can initiate a trigger to remember details of a current activity by selecting the remember selector 720 (e.g., a selectable button) presented within the display 161 of the electronic device 100. Based on detecting the trigger to remember, the MDAM module 125 (FIG. 1A) can cause operations to be performed to analyze and determine the context(s) of the on-going activities 705 and 725. The MDAM module 125 can also cause operations to be performed to remember or store, in the data storage device(s) 141, the information related to the activities 705 and 725, the associated context(s), and when applicable, the indication of sharing of similar context(s).

FIG. 7B illustrates an example recall selector 785 presented within the display 161 of electronic device 100, along with information related to activities that the user 102 is engaging in using the electronic device 100 during a second time period, according to one or more embodiments. The recall selector 785 enables recalling information previously remembered during the first time period. With the electronic device 100, information related to an example facetime meeting activity 765 during the second time period is presented within window 770 of the display 161. For example, the facetime meeting activity 765 can show a video 768 of the other person that the user 102 is having a discussion. In one or more embodiments, the information related to the facetime meeting activity 765 can be transcribed, recorded and presented within window 772 of the display 161.

When applicable, the user 102 can initiate a trigger to recall by selecting the recall selector 785 (e.g., a selectable button) presented within the display 161 of the electronic device 100. Based on detecting the trigger to recall, the MDAM module 125 (FIG. 1A) can cause operations to be performed to analyze the information related to the facetime meeting activity 765 to determine a context. Alternatively, the context of the facetime meeting activity 765 can be determined automatically by the MDAM module 125 while the meeting is on-going and prior to detecting the trigger to recall.

The determined context associated with an on-going activity can be used to search the data storage device(s) 141 to retrieve or recall information previously remembered and associated with a context similar to the determined context. Based on not finding any previously remembered information sharing a context similar to the determined context, a notification specifying a negative search result can be generated and presented to the user 102. Alternatively, based on finding previously remembered information sharing a context similar to the determined context, the previously remembered information can be presented to the user 102. As illustrated in FIG. 7B, the previously remembered information is presented within windows 775 and 780 of the display 161. As previously described, the trigger to recall can be initiated automatically by automatically determining the context of the information related to the on-going activity (e.g., the facetime meeting activity 765.)

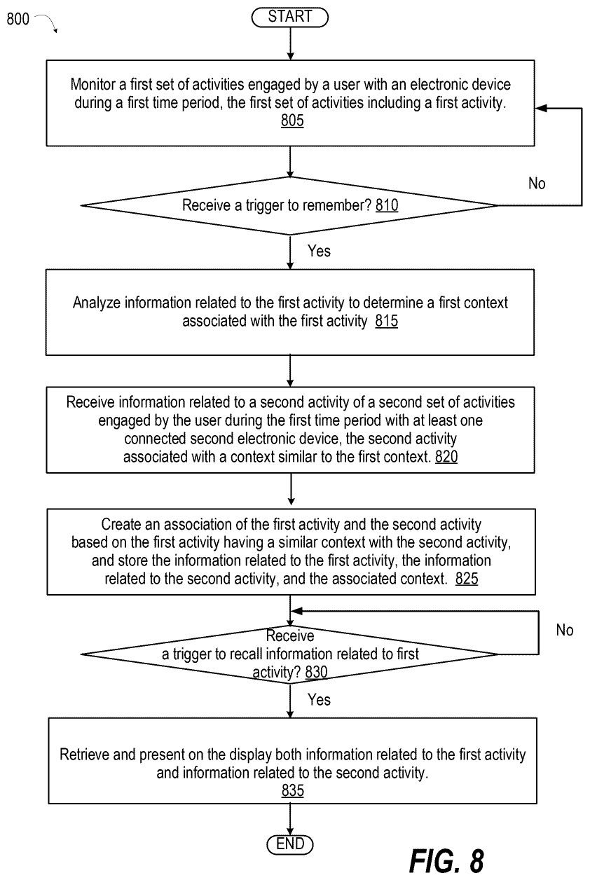

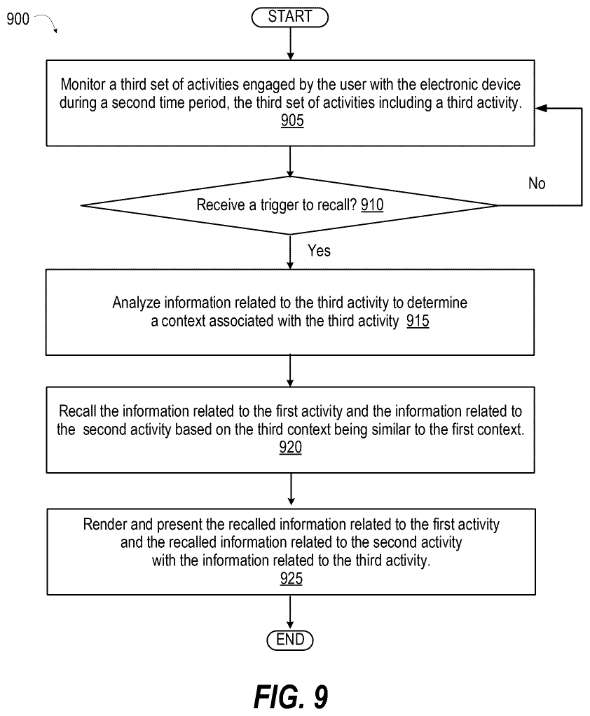

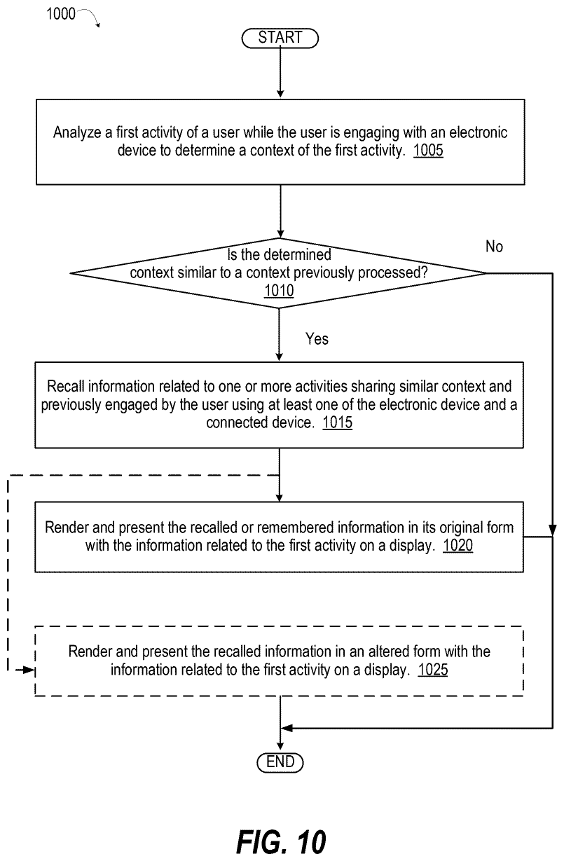

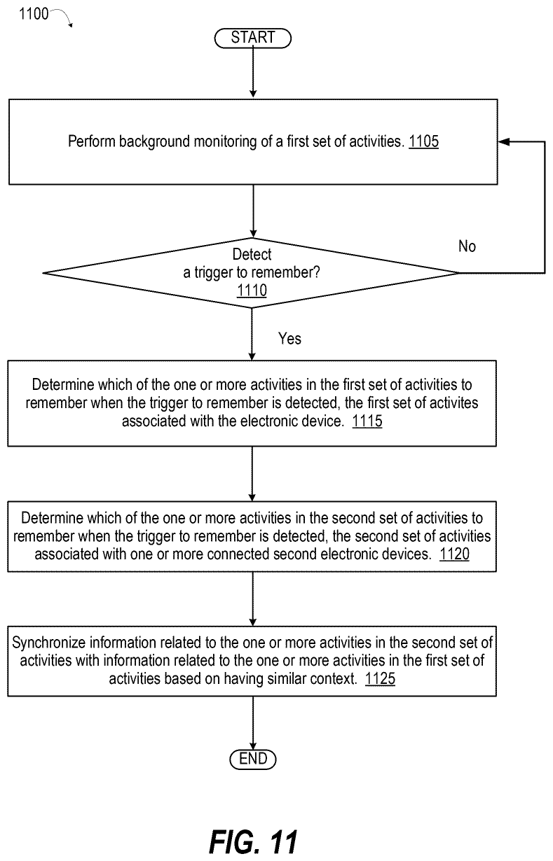

FIG. 8 is a flow diagram presenting computer-implement method for remembering information related to activities engaged in by the user during one time period and for recalling the remembered information during a subsequent time period in response to determining that a context associated with the remembered information being similar to a context related to an on-going activity, in accordance with one or more embodiments. FIG. 9 is a flow diagram presenting a computer-implement method 900 that augments method 800 of FIG. 8 for recalling previously remembered information in response to determining a context of a third activity sharing a similar context with previously remembered information. FIG. 10 is a flow diagram presenting a computer-implement method 1000 that augments method 800 of FIG. 8 and method 900 of FIG. 9 for automatically recalling previously remembered information and presenting the recalled or remembered information in an original form or in an altered form. FIG. 11 is a flow diagram presenting a computer-implement method 1100 that augments method 800 of FIG. 8 for determining which of the one or more activities in the first set of activities and which of the one or more activities in the second set of activities to remember when a trigger to remember is detected.

The descriptions of method 800 (FIG. 8), method 900 (FIG. 9), method 1000 (FIG. 10), and method 1100 (FIG. 11) is provided with general reference to the specific components illustrated within the preceding FIGS. 1-7. Specific components referenced in method 800 (FIG. 8), method 900 (FIG. 9), method 1000 (FIG. 10), and method 1100 (FIG. 11) may be identical or similar to components of the same name used in describing preceding FIGS. 1-7. In one or more embodiments, controller 110 (FIG. 1A) configures electronic device 100 (FIGS. 1A-1B) or a similar computing device (e.g., second device 104) to provide the described functionality of method 800 (FIG. 8), method 900 (FIG. 9), method 1000 (FIG. 10), and method 1100 (FIG. 11).

With reference to FIG. 8, method 800 includes performing background monitoring for a first set of activities engaged by the user 102 with the electronic device 100 during a first time period (block 805). The first set of activities may include one or more activities. The one or more activities can include a video meeting activity, a phone conversation activity, a text messaging activity, a facetime activity, an Internet browsing activity, a word processing activity, etc. Method 800 includes determining whether a trigger to remember (details of a current activity) is received/detected (decision block 810). Method 800 includes, in response to not detecting a trigger to remember, continuing to monitor activities occurring at/on the device and for the trigger to remember (block 805). In response to detecting receipt of a trigger to remember, method 800 includes analyzing information related to the first activity to determine a first context associated with the first activity (block 815).

The analysis of the information related to the first activity can be performed using an artificial intelligence (AI) engine 115 (FIG. 2) trained to predict/suggest/provide/present the context associated with information related to the first activity. In one or more embodiments, the AI engine 115 is trained at least in part based on crowd-sourced inputs. In one or more embodiments, the AI engine 115 is trained at least in part based on inputs originating from or associated with the user 102. In an example, AI engine 115 is or includes one or more of AI OS 117 and AI model 126.

Method 800 includes receiving information related to a second activity of a second set of activities engaged by the user 102 during the first time period with at least one connected second electronic device. The information related to the second activity can be analyzed by the AI engine 115 to determine a context associated with the second activity. Method 800 includes determine, e.g., by the AI engine 115, whether the second activity is associated with a context similar to the first context (block 820), and creating, e.g., via the AI engine 115, an association of the first activity and the second activity based on the first activity and the second activity sharing a similar context (block 825). In one or more embodiments, the information related to the first activity, the information related to the second activity, and the associated context can be stored in the data storage device(s) 141.

In one or more embodiments, method 800 may further include performing background monitoring for inputs received by the electronic device 100 correlated to a trigger, issued by the user 102, to recall specific data/information. The trigger to recall can be issued while the user 102 is engaging in an activity. For example, the user 102 wants to review previously remembered information having similar context to a document that the user 102 is generating. Alternatively, the trigger to recall can be issued without requiring the user 102 to be engaged in an activity. For example, the user 102 may want to review previously remembered information about a particular topic.

Method 800 includes determining whether a trigger to recall information related to first activity is detected (decision block 830). In the absence of detecting a trigger to recall, method 800 continues to monitor at block 830 for a trigger to recall. In response to detecting a trigger to recall, method 800 includes retrieving stored information from the data storage device(s) 141 and presenting, on a display of the electronic device 100, the information related to the first activity and the information related to the second activity (block 835).

With reference to FIG. 9, method 900 may further include performing background monitoring of a third set of activities engaged by the user with the electronic device 100 during a second time period, the third set of activities including a third activity (block 905). The second time period is subsequent to the first time period described in method 800. Method 900 includes determining whether a trigger to recall information related to third activity is detected (decision block 910). In response to there not being a trigger to recall, method 900 continues to monitor at block 905 for a trigger to recall. In response to detecting a trigger to recall, method 900 includes analyzing information related to the third activity to determine a context associated with the third activity (block 915).

Method 900 includes recalling the information related to the first activity and the information related to the second activity based on the context associated with the third activity being similar to the context associated with the first activity and the second activity (block 920). The recalling operations in block 920 include operations to retrieve the information related to the first activity and the information related to the second activity from the data storage device(s) 141. Subsequent to the operations of block 920, method 900 includes rendering and presenting the recalled information related to the first activity and the recalled information related to the second activity along with the information related to the third.

In a scenario where the information related to the first activity and the information related to the second activity do not share a similar context, no association is made between the first activity and the second activity. For example, the information related to the first activity can be associated with a context that involves travelling, while the information related to the second activity can be associated with a context that involves construction. Thus, when a context associated with the third activity also involves travelling, then the context associated with the third activity is similar to the context associated with the first activity. In such situation, the operations of block 920 may include recalling the information related to only the first activity. The recalled information related to the first activity would then be rendered and presented with the information related to the third activity.

With reference to FIG. 10, method 1000 may include analyzing an activity engaged in by the user 102 with the electronic device 100 to determine a context associated with the activity (block 1005). The operations performed in block 1005 may be performed using the AI engine 115 (FIG. 2). Method 1000 includes determining whether the determined context is similar to a context previously processed (decision block 1010). A context that is previously processed can be a context that was determined from a previous activity engaged by the user 102, and information related to the previous activity may have been stored in the data storage device(s) 141 based on detecting a trigger to remember one or more details/information of the activity. In response to determining that the context of an on-going activity is not similar to any context previously processed, the method 1000 ends because there is no previously remembered information related to the on-going activity. In response to determining that the context has previously been processed, the information related to the context can be recalled or retrieved from the data storage device(s) 141 (block 1015). The recalled information can be related to an activity that the user 102 engaged in with the electronic device 100 and/or the connected second electronic device(s) 104 during an earlier time period.

Method 1000 includes rendering and presenting the recalled information to the user 102 in the original form as when the information was captured and remembered (block 1020). Alternatively, method 1000 includes (shown in hyphenated lines and blocks) rendering and presenting the recalled information to the user 102 in an altered form from the original form when the information was captured and remembered (block 1025). For example, the operations in block 1025 may be performed in response to detecting a setting that the user 102 prefers to be presented with a summary or condensed version of the recalled information. In one or more embodiments, the recalled information can be rendered or presented together with information related to an on-going activity that the user 102 is engaging in, using the electronic device 100. In one or more embodiments, the recalled information can be rendered or presented to the user 102 within a window of the display(s) 161 (FIG. 1A) based on the user 102 providing a context and not based on the user 102 engaging in an activity.

With reference to FIG. 11, method 1100 may include communicatively connecting, via a communications subsystem, from the electronic device 100 to the one or more connected second electronic device(s) 104. Method 1100 may further include performing background monitoring of activities engaged in by the user 102 with the electronic device 100 and one or more connected second electronic device(s) 104. This includes monitoring a first set of activities engaged in by the user with the electronic device 100 during a first time period (block 1105). The first set of activities is associated with the electronic device 100. Method 1100 includes determining whether a trigger to remember is detected (decision block 1110). In response to not receiving/detecting a trigger to remember, method 1100 continues to monitor at block 1105. In response to receiving/detecting a trigger to remember, method 1100 includes determining which of the one or more activities in the first set of activities to remember when the trigger to remember is detected (block 1115). As described with the examples in FIG. 7A and FIG. 7B, the user 102 can issue a trigger to remember by selecting the remember selector 720 presented in association with an activity that the user 102 is engaging in.

Further, in response to detecting the trigger to remember, method 1100 includes determining which of the one or more activities in the second set of activities to remember when the trigger to remember is detected (block 1120). Information related to a second activity in the second set of activity can be analyzed by the AI engine 115 to determine a context associated with the second activity. The second set of activities is associated with one or more connected second electronic devices. Method 1100 further includes synchronizing information related to the one or more activities in the second set of activities with information related to the one or more activities in the first set of activities based on the two sets of activities having similar context (block 1125). The synchronizing of the information related to the one or more activities in the second set of activities with information related to the one or more activities in the first set of activities can be performed using the AI engine 115 trained to determine/predict/suggest/present a context and to determine that the context is similar.

According to aspects of the present disclosure, the electronic device 100 (FIG. 1A), method 800 (FIG. 8), method 900 (FIG. 9), method 1000 (FIG. 10), method 1100 (FIG. 11) and computer program product, such as RSD 145 (FIG. 1A), provide techniques for: detecting trigger(s) to remember information related to activities engaged by the user 102 (FIG. 1A) using the electronic devices 100 and connected second electronic device(s) 104 during one time period, for performing operations to remember; detecting trigger(s) to recall previously remembered information using the electronic device 100 during a subsequent time period; and performing operations to recall to provide the user 102 a more complete set of information while engaging in an on-going activity associated with a context similar to the context of the recalled information.

According to one or more embodiments, one or more of methods 800/900/1000/1100 further include the processor: in response to the association of the first activity and the second activity based on the second context being similar to the first context, storing at least the information related to the first activity and the information related to the second activity along with the association of the first activity and the second activity in a storage device during the first time period; and processing the request to recall the information by retrieving, from the storage device during the second time period, at least the information related to the first activity and the information related to the second activity.

According to one or more embodiments, one or more of methods 800/900/1000/1100 further include the processor: monitoring a third set of activities engaged in by the user with the electronic device during a second time period, the third set of activities including a third activity; determining, by analyzing information related to the third activity, that a third context associated with the third activity is similar to or corresponds with the first context; and in response to receiving a trigger to remember information related to the third activity, storing the information related to the third activity together with the information related to the first activity and the second activity based on the first context, the second context, and the third context being similar.

According to one or more embodiments, one or more of methods 800/900/1000/1100 further include the processor, in order to analyze the information related to the first set of activities to determine a first context, parsing information related to the first set of activities for key themes, topics, actions, and actors. The processor further causes the electronic device to: identify each active connected second device; retrieve from each active connected second electronic device a next set of second activities occurring on the second electronic device; and analyze the next set of second activities to identify correlations of key themes, topics, actions and actors that match those of the first set of activities.

According to one or more embodiments, one or more of methods 800/900/1000/1100 further include the processor: extracting relevant information from the second set of activities that are corelated with the first set of activities; tagging the relevant information with context data; and storing the tagged relevant information in a structure format, where the second electronic device 104 and the electronic device 100 are interconnected within an ecosystem of user devices utilized by a single user entity who utilizes each of the user devices of the ecosystem.

According to one or more embodiments, one or more of methods 800/900/1000/1100 further include the processor: determining, in part based on the context, an intent of the set of activities; transforming the tagged relevant information into a different presentation format based on the determined intent; generating and presenting a task to be completed, based on the information extracted from the set of activities; assigning one or more triggers to the tagged relevant information; and retrieving and surfacing/presenting the tagged relevant information on the display, in response to detection of a trigger from among the one or more assigned triggers.

According to one or more embodiments, one or more of methods 800/900/1000/1100 further include the processor determining that each of the first activity and the second activity being at least an activity from among a group comprising: (i) engaging in a voice call; (ii) engaging in a text messaging session; (iii) engaging in an online meeting; (iv) watching a video; (v) engaging in a chat session; (vi) browsing using a network browser; and (vii) generating a document.

According to one or more embodiments, one or more of methods 800/900/1000/1100 further include the processor determining at least the first context and the second context using an artificial intelligence (AI) engine trained to predict a context associated with an activity engaged by the user using the electronic device or the at least one connected second electronic device, and where the AI engine is further trained to extract the information related to the first activity and the information related to the second activity, and predict triggers that can be used to recall remembered information stored in a storage device.

By providing the user 102 (FIG. 1A) with information previously remembered based on associated context(s), electronic device 100 prevents forgetting and/or overlooking information related to activities previously engaged in by the user 102 that can be helpful with an on-going activity or with an activity that the user 102 is about to engaged in. In particular, the electronic device 100 performs various techniques for remembering information and recalling information when the user 102 is using multiple electronic devices concurrently.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
at least one input device;
at least one output device, including a display;
a communications subsystem that connects the electronic device to at least one connected second electronic device via a communication network;
a processor communicatively coupled to the at least one input device, the at least one output device, and the communications subsystem, and which is configured to cause the electronic device to:
monitor a first set of activities engaged in by a user with the electronic device during a first time period;
in response to receiving a trigger to remember information related to a first activity in the first set of activities:
analyze the information related to the first activity to determine a first context associated with the first activity;
receive, via the communication subsystem from the at least one connected second electronic device, information related to a second set of activities engaged in by the user with the at least one connected second electronic device during the first time period, the second set of activities including a second activity having a second context that is similar to the first context;
create an association of the first activity and the second activity based on the second context being similar to the first context; and
in response to subsequently receiving a request, during a later time period, for a recall of information related to the first activity, automatically retrieve and present on the display both information related to the first activity and information related to the second activity.

2. The electronic device of claim 1, further comprising a storage device, and wherein the processor is further configured to cause the electronic device to:
in response to the association, store at least the information related to the first activity and the information related to the second activity along with the association of the first activity and the second activity in the storage device during the first time period; and
process the request to recall the information by retrieving, from the storage device during the second time period, at least the information related to the first activity and the information related to the second activity.

3. The electronic device of claim 1, wherein the processor is further configured to cause the electronic device to:
monitor a third set of activities engaged in by the user with the electronic device during a second time period, the third set of activities including a third activity;
determine, by analyzing information related to the third activity, that a third context associated with the third activity is similar to or corresponds with the first context; and
in response to receiving a trigger to remember information related to the third activity, store the information related to the third activity together with the information related to the first activity and the second activity based on the first context, the second context, and the third context being similar.

4. The electronic device of claim 3, wherein the processor is further configured to cause the electronic device to:
in response to receiving a request to recall remembered information related to the third activity, identify and present the information related to the first activity and the information related to the second activity along with the information related to the third activity, based on the first context, the second context, and the third context being similar.

5. The electronic device of claim 1, wherein:
to analyze the information related to the first set of activities to determine a first context, the processor is further configured to parse information related to the first set of activities for key themes, topics, actions, and actors; and
the at least one processor further causes the electronic device to:
identify each active connected second device;
retrieve from each active connected second electronic device a next set of second activities occurring on the second electronic device; and
analyze the next set of second activities to identify correlations of key themes, topics, actions and actors that match those of the first set of activities.

6. The electronic device of claim 5, wherein the processor is further configured to cause the electronic device to:
extract relevant information from the second set of activities that are corelated with the first set of activities;
tag the relevant information with context data; and
store the tagged relevant information in a structure format.

7. The electronic device of claim 6, wherein the processor is further configured to cause the electronic device to:
determine, in part based on the context, an intent of the set of activities; and
transform the tagged relevant information into a different presentation format based on the determined intent.

8. The electronic device of claim 6, wherein the processor is further configured to cause the electronic device to:
generate and present a task to be completed, based on the information extracted from the set of activities.

9. The electronic device of claim 6, wherein the processor is further configured to cause the electronic device to:
assign one or more triggers to the tagged relevant information; and
retrieve and surface/present the tagged relevant information on the display, in response to detection of a trigger from among the one or more assigned triggers.

10. The electronic device of claim 1, wherein each of the first activity and the second activity comprises at least an activity from among a group comprising: (i) engaging in a voice call; (ii) engaging in a text messaging session; (iii) engaging in an online meeting; (iv) watching a video; (v) engaging in a chat session; (vi) browsing using a network browser; and (vii) generating a document.

11. The electronic device of claim 1, wherein the processor is further configured to cause the electronic device to:
perform background monitoring of the first set of activities;
determine which of the one or more activities in the first set of activities to remember when the trigger to remember is received;
determine which of the one or more activities in the second set of activities to remember when the trigger to remember is received; and
synchronize information related to the one or more activities in the second set of activities with information related to the one or more activities in the first set of activities when the trigger to remember is received.

12. The electronic device of claim 1, wherein the processor is further configured to cause the electronic device to:
determine at least the first context and the second context using an artificial intelligence (AI) engine trained to predict a context associated with an activity engaged by the user using the electronic device or the at least one connected second electronic device, and where the AI engine is further trained to extract the information related to the first activity and the information related to the second activity, and predict triggers that can be used to recall remembered information stored in a storage device.

13. The electronic device of claim 1, wherein the second electronic device and the electronic device are interconnected within an ecosystem of user devices utilized by a single user entity who utilizes each of the user devices of the ecosystem.

14. A method comprising:
monitoring a first set of activities engaged in by a user with an electronic device during a first time period;
in response to receiving a trigger to remember information related to a first activity in the first set of activities:
analyzing the information related to the first activity to determine a first context associated with the first activity;
receiving, from at least one connected second electronic device, information related to a second set of activities engaged in by the user with the at least one connected second electronic device during the first time period, the second set of activities including a second activity having a second context that is similar to the first context;
creating an association of the first activity and the second activity based on the second context being similar to the first context; and
in response to subsequently receiving a request, during a later time period, for a recall of information related to the first activity, automatically retrieving and presenting on the display both information related to the first activity and information related to the second activity.

15. The method of claim 14, further comprising:
in response to the association, storing at least the information related to the first activity and the information related to the second activity along with the association of the first activity and the second activity in a storage device during the first time period; and
processing the request to recall the information by retrieving, from the storage device during the second time period, at least the information related to the first activity and the information related to the second activity.

16. The method of claim 14, further comprising:
monitoring a third set of activities engaged in by the user with the electronic device during a second time period, the third set of activities including a third activity;
determining, by analyzing information related to the third activity, that a third context associated with the third activity is similar to or corresponds with the first context; and
in response to receiving a trigger to remember information related to the third activity, storing the information related to the third activity together with the information related to the first activity and the second activity based on the first context, the second context, and the third context being similar.

17. The method of claim 16, further comprising:
in response to receiving a request to recall remembered information related to the third activity, identifying and presenting the information related to the first activity and the information related to the second activity along with the information related to the third activity, based on the first context, the second context, and the third context being similar.

18. The method of claim 14, wherein analyzing the information related to the first set of activities to determine a first context comprises parsing information related to the first set of activities for key themes, topics, actions, and actors.

19. The method of claim 18, further comprising:
identifying each active connected second device;
retrieving from each active connected second electronic device a next set of second activities occurring on the second electronic device;
analyzing the next set of second activities to identify correlations of key themes, topics, actions and actors that match those of the first set of activities.

20. A computer program product comprising:
a computer readable storage device; and
program code on the computer readable storage device that when executed by a processor associated with an electronic device, the program code is configured to cause the electronic device to provide functionality of:
monitoring a first set of activities engaged in by a user with an electronic device during a first time period;
in response to receiving a trigger to remember information related to a first activity in the first set of activities:
analyzing the information related to the first activity to determine a first context associated with the first activity;
receiving, from at least one connected second electronic device, information related to a second set of activities engaged in by the user with the at least one connected second electronic device during the first time period, the second set of activities including a second activity having a second context that is similar to the first context;
creating an association of the first activity and the second activity based on the second context being similar to the first context; and
in response to subsequently receiving a request, during a later time period, for a recall of information related to the first activity, automatically retrieving and presenting on the display both information related to the first activity and information related to the second activity.
